(19) United States
(12) Patent Application Publication
(10) Pub. No.: US 2005/0030909 A1
(43) Pub. Date: Feb. 10, 2005

(54) Amplifier for downstream and upstream signals

(76) Inventors: Rainer Schmidt, Loderburg (DE); Bernhard Stascheit, Braunschweig (DE); Gunter Widera, Hildesheim (DE)

Correspondence Address: Merchant & Gould, P O Box 2903, Minneapolis, MN, 55402-0903, US

(21) Appl. No.: 10/497,645

(22) PCT Filed: Dec. 4, 2002
(86) PCT No.: PCT/EP02/13949

(30) Foreign Application Priority Data
Dec. 5, 2001 (EP) 01128922.0

(51) Int. Cl. H04L 5/14

(52) U.S. Cl. 370/276

(57) ABSTRACT

The invention relates to an amplifier, in particular for a cable or optical network, for downstream and upstream signals that are transmitted in different frequency bands. The amplifier comprises, a first and a second connector, a common amplifier element for downstream and upstream signals, a first and a second downstream-signal filter, and a first and a second upstream-signal filter. An input of the amplifier element is connected to an output of the first downstream-signal filter as well as to an output of the first upstream-signal filter; an output of the amplifier element is connected to an input of the second downstream-signal filter as well as to an input of the second upstream-signal filter; the first connector communicates with the output of the second upstream-signal filter and the input of the first downstream-signal filter; and the second connector communicates with the output of the second downstream-signal filter and the input of the first upstream-signal filter.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention relates to an amplifier in particular for downstream and upstream signals that are transmitted in different frequency bands.

### BACKGROUND OF THE INVENTION

Amplifiers for downstream and upstream signals are employed in particular in cable networks. Here a downstream channel takes the form of a frequency band in which the downstream signals are transmitted from a central distributor node to a plurality of receivers, such as set-top boxes. In order to transmit signals back from a receiver to a distributor node, an upstream channel is provided, which is formed by a frequency band different from the frequency band of the downstream channel. Thus, by using various frequency bands, signals can be transmitted in different directions by way of, for example, a coaxial cable or an optical waveguide within a cable or optical network.

In the following, for simplicity, reference will be made only to “cable network ” or “cable system ”, but these should not be understood as restrictive terms. In principle the technology can also be advantageously employed for optical networks.

In a cable network the upstream channel as a rule serves to transmit control information from, for instance, a set-top box to a “head end ” or distributor node. There the control information can be evaluated. The upstream channel gains special significance in the case of so-called cable modems. These use the downstream channel for downloading data, and the upstream channel for uploading.

In Germany present-day cable networks make use of two different conventions to specify the frequency-range subdivisions for transmission of downstream and upstream signals. According to the first convention, the frequency spectrum from 5 to 30 MHz is used as the upstream channel, or upstream range, and 47 to 862 MHz is used as the downstream channel or range. Thus distinctly more bandwidth is available for downstream than for upstream transmission. The downstream band serves chiefly for the transmission of information signals. In a second convention commonly used in Germany, the upstream channel is in the range from 5 to 65 MHz and the downstream channel, from 85 to 862 MHz. That is, the bandwidth of the downstream channel is somewhat smaller, and the bandwidth of the upstream channel somewhat greater than in the first type of subdivision.

The subdividions of the frequency spectrum available for signal transmission are, as a rule, country- and standard-specific. Thus for cable networks in the USA the frequency spectrum is subdivided differently than it is in Germany.

The amplifiers for cable networks mentioned at the outset are customarily adapted to a particular type of frequency subdivision. This is disadvantageous, as it means that to be used in various cable networks in different countries, appropriately adapted amplifiers must be provided. Furthermore, such amplifiers are cost-intensive, because their components such as filters and amplification elements in the downstream channel must be separate from those in the upstream channel. An additional substantial disadvantage is that the upstream bandwidth is very much smaller than the downstream bandwidth, and this cannot be readily changed. To alter the bandwidth for the individual transmission ranges involves considerable technical effort, in particular an exchange of frequency-determining components.

FIG. 2 shows an exemplary embodiment of a known amplifier for a cable network. It comprises two almost completely separated signal paths for downstream and upstream signals. Downstream input signals 50 are sent to a downstream amplifier element 58 by way of a first high-pass filter 54. Its output signals are in turn sent through a second high-pass filter 62 and from there are transmitted as downstream output signals 66 of the amplifier, for example to a receiver such as a set-top box in the cable network. Conversely, upstream input signals 68 from, for instance, a set-top box are passed through a first low-pass filter 64 and on to the next component, an upstream amplifier element 60. To the output of the latter is connected a second low-pass filter 56, which transmits the amplified signals, in the form of upstream output signals 52, to a receiver such as a distributor node in the cable network.

For reasons of economy, in this amplifier the components of the downstream and of the upstream channel are adapted to the bandwidth of the signals to be processed. As a result, the limiting frequencies and hence the pass bands are permanently fixed, so that the amplifier can be used only for a quite specific type of frequency subdivision.

### BRIEF SUMMARY OF THE INVENTION

The objective of the present invention is to disclose an amplifier for downstream and upstream signals that can be adapted to different types of frequency subdivision with no need for elaborate technical measures.

An essential idea of the invention resides in the fact that components of an amplifier provided for the processing of downstream signals are also used, at least in part, for upstream signals. Because the downstream signals, especially in cable networks, have a much greater bandwidth than the upstream signals, and furthermore are in higher frequency ranges, the components provided for processing downstream signals are correspondingly designed and hence are in principle also suitable for processing upstream signals. The amplifier element for downstream signals, in particular, is normally a broadband amplifier, which can advantageously likewise be used to amplify the upstream signals. The invention allows an expensive component—namely the amplifier element for upstream signals—to be eliminated. As a result a more economical amplifier is created, which requires fewer components than do conventional amplifiers for downstream and upstream signals, while preserving the same level of functionality. In addition, the amplifier in accordance with the invention is flexible and can more readily be adapted to changes in the frequency ranges, such as altered pass bands. These alterations can be achieved merely by changing the filters, so that their transmission bands are defined by limiting frequencies adjusted according to the desired modification.

According to the present invention there is provided an amplifier for downstream and upstream signals that are transmitted by way of different frequency bands the amplifier comprising
a first and a second connector,
a common amplifier element for downstream and upstream signals,
a first and a second downstream-signal filter, and
a first and a second upstream-signal filter
   wherein an input of the amplifier element is connected to an output of the first downstream-signal filter as well as to an output of the first upstream-signal filter, and an output of the amplifier element is connected to an input of the second downstream-signal filter as well as to an input of the second upstream-signal filter; the first connector communicates with the output of the second upstream-signal filter and the input of the first downstream-signal filter, while the second connector communicates with the output of the second downstream-signal filter and the input of the first upstream-signal filter. An amplifier of this kind can advantageously be employed, for example, in already existing cable networks or also in new cable systems as well as in optical networks.

In one embodiment the downstream-signal and upstream-signal filters can each comprise a plurality of filters connected in series and/or in parallel. In this case a first plurality of filters is provided to constitute the at least one series and/or parallel circuit for downstream signals, and a second plurality of filters is provided to constitute the at least one series circuit for upstream signals. That is, a particular signal direction is not necessarily associated with a particular type of filter. In principle, any arbitrary set of filters can be connected for the purpose of transmitting the downstream and upstream signals.

The amplifier element can be a broadband amplifier. Its gain characteristic should encompass a frequency range that includes the frequency bands for both downstream and upstream signals.

Between the first connector and the adjacent components, namely the output of the second upstream-signal filter and the input of the first downstream-signal filter, an equalizer can be inserted into the circuit, to allow the circuit to be adapted to a transmission line connected thereto, in particular a coaxial cable.

So that additional signal blocks can be coupled into the upstream route, a signal-incorporation arrangement can be provided between the input of the amplifier element and the output of the first upstream-signal filter.

It is also possible to dispose in the circuit, between the input of the amplifier element and the signal-incorporation arrangement, a signal-level adjustment device which, for example, serves to adjust the level of the upstream signals.

Preferably the amplifier processes electrical signals. Alternatively, however, it can also process optical signals.

One preferred application of the amplifier in accordance with the invention is as part of a cable network. Equally advantageously, the amplifier in accordance with the invention can be employed in an optical network.

In the following the invention is explained with reference to an exemplary embodiment of an amplifier for downstream and upstream signals, the description of which is assisted by the attached drawings.

### BRIEF DESCRIPTION OF THE SEVERAL VIEWS OF THE DRAWINGS

FIG. 2 shows an amplifier for downstream and upstream signals in a cable network, such as is known in the state of the art, whereas

FIG. 1 shows an exemplary embodiment of an amplifier for downstream and upstream signals in accordance with the invention.

### DETAILED DESCRIPTION OF THE INVENTION

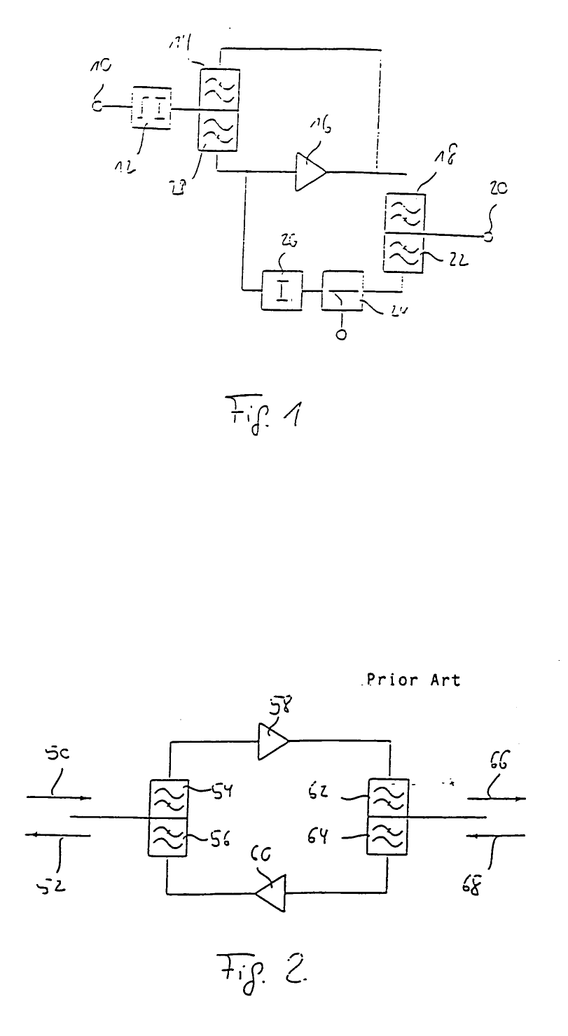

Regarding FIG. 2, reference is made to the explanation given in the introductory part of the Description.

The amplifier shown in FIG. 1 is designed for use in a cable network. It comprises a first connector 10, which serves as input for downstream signals and output for upstream signals. The connector 10 is connected to a first coaxial cable (not shown) so that it can exchange signals with a distributor node of the cable network. An equalizer 12 serves to linearize the amplitude response of the coaxial cable over the entire frequency band available for the transmission of downstream and upstream signals.

Downstream signals are sent from the equalizer 12 through a first high-pass filter 28 to the input of a broadband amplifier element 16. The first high-pass filter 28 filters the downstream signal out of the received signal spectrum. The pass band of the first high-pass filter 28 thus corresponds substantially to the frequency range of the downstream signals.

After amplification of the downstream signals by the broadband amplifier element 16, these signals are filtered through a second high-pass filter 18 and made available to a second connector 20 of the amplifier. To the second connector 20 is attached a second coaxial cable (not shown), which allows the amplifier to communicate, for example, with terminal device connected to the cable network, such as a set-top box or a cable modem, or with a distributor node or another amplifier.

The second connector 20 thus serves as output for downstream signals and input for upstream signals. The signal spectrum received by way of the second coaxial cable is, accordingly, sent by way of the second connector 20 through a first low-pass filter 22. This filters the received upstream signals and conducts them to a signal-incorporation arrangement 24.

The signal-incorporation arrangement 24 serves to couple additional signals or signal blocks into the upstream-signal flow. The signal-level adjustment device 26, which follows the signal-incorporation arrangement 24 in the circuit, is provided to influence the level of the upstream signals. Preferably the signals to be introduced by means of the signal-incorporation arrngement 24 are spectrally converted signal blocks, which with regard to their spectrum represent the upstream signals in their entirety. As a result, by means of appropriate reconversion, for example in an end station of the cable network, the original content of the additionally incorporated signals can be retrieved.

Considering the situation in which the amplifier shown in FIG. 1 is the distribution point in a cable network, the following events occur. Upstream signals coming from a subscriber's terminal arrive at this distribution point. So that signals of the same kind can be incorporated into the upstream signal flow by way of the signal-incorporation arrangement 24 without affecting the upstream signals from the subscriber's terminal, the signals that are to be incorporated must be shifted in terms of frequency and/or temporally. This can be achieved in accessory devices that are not shown here. The appropriately time- and/or frequency-shifted signals are then coupled into the upstream signal flow by way of the signal-incorporation arrangement 24, without exerting any influence on the upstream signals from the subscriber's terminal. The signal-level adjustment device 26 can then be used for one of its purposes, namely to affect the level of the upstream signals at the input of the amplifier element 16.

From the signal-level adjustment device 26 the upstream signals are sent to the input of the broadband amplifier element 16, where they are amplified and sent on to the equalizer 12 by way of a second low-pass filter 14. The equalizer predistorts the amplified upstream signals it has received, and makes them available to other elements at the first connector 10. Then, by way of the first coaxial cable, the upstream signals can be transmitted to, for example, a distributor node or amplifier station (neither of which is shown in the figure).

### List of Reference Numerals

10 1st connector
12 Equalizer
14 2nd upstream-signal filter (2nd low-pass filter)
16 Amplifier element (broadband amplifier element)
18 2nd downstream-signal filter (2nd high-pass filter)
20 2nd connector
22 1st upstream-signal filter (1st low-pass filter)
24 Signal-incorporation arrangement
26 Signal-level adjustment device
28 1st downstream-signal filter (1st high-pass filter)
50 Downstream input signals
52 Upstream output signals
54 1st high-pass filter
56 2nd low-pass filter
58 Downstream amplifier element
60 Upstream amplifier element
62 2nd high-pass filter
64 1st low-pass filter
66 Downstream output signals
68 Upstream input signals

1. Amplifier for downstream and upstream signals, wherein the signals are transmitted in different frequency bands, comprising
a first and a second connector,
a common amplifier element for downstream and upstream signals,
a first and a second downstream-signal filter, and
a first and a second upstream-signal filter,
wherein
an input of the amplifier element is connected to an output of the first downstream-signal filter as well as to an output of the first upstream-signal filter;
an output of the amplifier element is connected to an input of the second downstream-signal filter as well as to an input of the second upstream-signal filter;
the first connector communicates with the output of the second upstream-signal filter and the input of the first downstream-signal filter; and
the second connector communicates with the output of the second downstream-signal filter and the input of the first upstream-signal filter.

2. Amplifier according to claim 1, wherein the downstream-signal and upstream-signal filters each comprise at least one of a series circuit made up of a plurality of filters and a parallel circuit made up of a plurality of filters, such that a first plurality of filters in said at least one series circuit and parallel circuit is provided for downstream signals and a second plurality of filters in said at least one series circuit and parallel circuit is provided for upstream signals.

3. Amplifier according to claim 1, wherein the common amplifier element is a broadband amplifier element.

4. Amplifier according to claim 1, wherein an equalizer is disposed between the first connector and the output of the second upstream-signal filter and between the first connector and the input of the first downstream-signal filter.

5. Amplifier according to claim 1, wherein a signal-incorporation arrangement is provided between the input of the amplifier element and the output of the first upstream-signal filter to incorporate additional signals into the upstream signal flow.

6. Amplifier according to claim 1, wherein a signal-level adjustment device is provided between the input of the amplifier element and the signal-incorporation arrangement.

7. Amplifier according to claim 1, that processes electrical signals.

8. Amplifier according to claim 1, that processes optical signals.

9. Application of an amplifier according to claim 1 in a cable network.

10. Application of an amplifier according to claim 1 in an optical network.
